(19) United States
(12) Patent Application Publication
(10) Pub. No.: US 2009/0006241 A1
(43) Pub. Date: Jan. 1, 2009

(54) System and Method for Displaying Multiple Charts of Related Stock Candidates and its Method

(76) Inventors: Xirong Zhao, Fremont, CA (US); Wei Wang, Saratoga, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/772,117

(22) Filed: Jun. 30, 2007

(51) Int. Cl. G06Q 40/00

(52) U.S. Cl. 705/37

(57) ABSTRACT

A system to display multiple charts of related stock candidates and method thereof are described. Embodiments of the present invention solves problems of limited ability to simultaneously view multiple charts. It is an object of the present invention to provide for simultaneous viewing of multiple stock charts in one screen view.

### BACKGROUND OF INVENTION

1. Field of Invention

Aspects of the invention relate to the field of financial market information and, more particularly, to a system and method of providing, manipulating, selecting, and viewing stock market information.

2. Background

A need exists for quick and efficient simultaneous viewing of numerous stock charts in real-time. A need also exists for a system and method that increases available workspace and allows for the convenient searching of stocks within defined criteria.

Some existing products are designed to offer a single-chart display for trading stocks. A user of existing products clicks and/or scrolls from an individual stock chart to another individual stock chart to find stocks to trade.

Other existing products allow for simultaneous viewing of stock charts and market information, and are designed to simultaneously display multiple stock charts in a single screen. However, these existing products lack the ability to rapidly select and view multiple stock charts in the same user interface window and link a stock chart display window to a list of stocks the user desires to view.

Each of the currently existing products lack the ability to simultaneously display multiple stock charts in a single screen view while allowing a user to rapidly view a selected list of stocks.

The existing products mentioned above are not admitted to be prior art with respect to the present invention by their mention in this Background Section.

### SUMMARY OF THE INVENTION

The present invention is directed to a system and a method of a multiple link chart display system that satisfies the need to view numerous stocks rapidly and efficiency in an increased available user workspace.

In a preferred embodiment of the present invention, the computer implemented multiple link chart display system (herein after referred to as “the system”) allows users to simultaneously generate and view multiple stock charts while increasing the user's speed and efficiency in stock market analysis and trading.

In an embodiment of the present invention, the system allows a plurality of chart displays to be viewed in a patchwork-quilt configuration. Each chart display contains a stock chart and market indicators maintained in real-time. The chart displays are viewed simultaneously with a quote sheet display. A quote sheet display contains a list of stocks with other relevant stock information. The system allows a user to obtain a list of stocks, either user selected or computer selected, based on specific criteria and inputs the stocks into a quote sheet display.

The system allows a user to link a number of chart displays and a quote sheet display by color grouping, enabling the user to simultaneously view the stock charts of the stocks listed in the quote sheet display. When multiple chart displays are linked to the quote sheet display, the system allows a user to quickly view corresponding stock charts by scrolling with the paging function. The paging function, controlled by a scroll bar or other similar control in the quote sheet display, allows a user to view the next sequence of stocks without the need to manually load individual stock charts.

In another embodiment of the present invention, the system allows a user to quickly and instantly view the stock charts of a list of stocks in a single chart display. The system enables a user to link a single chart display to a quote sheet display and select a stock(s) by moving the mouse pointer over the stock(s) in the quote sheet display. The system then displays the stock chart of the selected stock in the linked chart display.

In another embodiment, the system allows a user to view a group of up to twenty stocks in a single screen view or layer. The system allows a user to establish up to four layers. Each layer is viewed and switch to another layer, by selecting the corresponding layer button in the main program window.

In an embodiment of the present invention, the system enables a user to search the market for stock trading candidates. The system provides a number of pre-programmed scans that search the stock market for stocks that fall within specific categories or criteria. The pre-programmed scans include searches for stocks in categories such as but not limited to, largest percentage gainer, day trading, and industry sector. These categories may further be narrowed into subcategories. The system also enables a user to establish the user's own individualized searches or scan lists. The system also enables a user to narrow the results retrieved from a scan by filtering the list of stocks with user specified criteria.

Implementations of the present invention include a method or process, an apparatus or system, or computer software on a computer-readable medium.

An embodiment of the present invention is a computer implemented system connected with a communications network for displaying real-time stock market information comprising of one or more processors coupled with a memory, and code stored in the memory that directs the one or more processors to provide a quote sheet display, listing a sequence of a plurality of stocks and provide a plurality of chart displays, each displaying a stock chart in real-time. Each of the plurality of chart displays is ranked relative to all the chart displays, hereinafter referred to as ranked chart displays, and is grouped for viewing at the same time along with the quote sheet display. The quote sheet display is linked with two or more of said ranked chart displays, such that the stock chart displayed in each of said ranked chart displays is retrieved from and corresponds to a stock in the sequence of stocks listed in the quote sheet display as selected by a user. The stock chart displayed in each of said ranked chart displays is changed to a different stock chart corresponding to a stock in the sequence of stocks as selected by the user when the user reviews the sequence of stocks in said quote sheet display.

Another embodiment is a method for displaying on a user interface a plurality of stock charts for viewing by a user comprising of generating a quote sheet display listing a sequence of a plurality of stocks, generating a plurality of chart displays, each displaying a stock chart in real-time, and ranking each chart display relative to all the chart displays, herein after referred to as ranked chart displays, as directed by said user. Then grouping the ranked chart displays for viewing at the same time, as directed by said user, and grouping the quote sheet display in relation to the ranked chart displays, as directed by said user. Grouping is followed by scrolling on the quote sheet display to view the stock charts of the stocks in said sequence, as directed by said user and displaying the stock charts of said sequence of stocks in the plurality of ranked chart displays.

Another embodiment of the present invention is a computer readable medium encoded with a computer program having computer executable instructions for displaying real-time stock market information, the instructions configured to provide a quote sheet display, listing a sequence of a plurality of stocks and provide a plurality of chart displays, each displaying a stock chart in real-time. Each of the plurality of chart displays is ranked relative to all the chart displays, hereinafter referred to as ranked chart displays, and is grouped for viewing at the same time along with the quote sheet display. The quote sheet display is linked with two or more of said ranked chart displays, such that the stock chart displayed in each of said ranked chart displays is retrieved from and corresponds to a stock in the sequence of stocks listed in the quote sheet display as selected by a user, and wherein the stock chart displayed in each of said ranked chart displays is changed to a different stock chart corresponding to a stock in the sequence of stocks as selected by the user when reviewing the sequence of stocks in said quote sheet display.

These and other embodiments of the present invention are further made apparent in the remainder of the present document to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a main program window of the user interface of the system according to an embodiment of the present invention.

FIG. 2 is a depiction of a user interface window for generating new charts, according to an embodiment of the present invention.

FIG. 3 is a chart display window of a selected stock with market indicators, according to an embodiment of the present invention.

FIG. 4 is a quote sheet display window, according to an embodiment of the present invention.

FIG. 5 is a quote sheet display window, according to an embodiment of the present invention.

FIG. 6 is a newly generated chart display window, according to an embodiment of the present invention.

FIG. 7 is a chart display window with color tags for linking, according to an embodiment of the present invention.

FIG. 8 is a scan sheet display with color tags for linking, according to an embodiment of the present invention.

FIG. 9 depicts a screen shot of three chart display windows and a quote sheet display window, according to an embodiment of the present invention.

FIG. 10 depicts a chart display window cutout of the screen shot of FIG. 9.

FIG. 11 depicts a quote sheet display window cutout of the screen shot of FIG. 9.

FIG. 12 depicts a screen shot of three chart display windows and a quote sheet display window, according to an embodiment of the present invention.

FIG. 13 depicts a user interface window listing the scan categories, according to an embodiment of the present invention.

FIG. 14 depicts a user interface window used for filtering scan lists, according to an embodiment of the present invention.

FIG. 15 is a flow diagram illustrating the method which the system allows a user to simultaneously view multiple stocks in an embodiment of the present invention.

FIG. 16 depicts a screen shot of a chart display showing how to rank the display by number, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

In an embodiment of the present invention, the multiple link chart display system is a system and method that allows a user to simultaneously display a variety of stock charts and indicators for analyzing stock movements to determine when to enter and leave the market. The present invention links chart displays with a quote sheet display enabling a user to efficiently and quickly assess the status or performance of stocks and subsequently make an informed trade.

In a preferred embodiment of the present invention, there is a computer implemented multiple link chart display system (herein after referred to as “the system”) comprising one or more processors, memory, code stored in the memory and a graphical user interface that allows a user to create, modify and view stock movement or performance in real-time. Stock information is displayed in real-time, in graphical form, such as a stock chart. The system enables a user to modify the content and appearance of a stock chart by changing the stock chart to display a weekly, daily or intraday chart. In an embodiment, the system allows a user to view a stock chart by days and hours, and/or any combination of time intervals thereof.

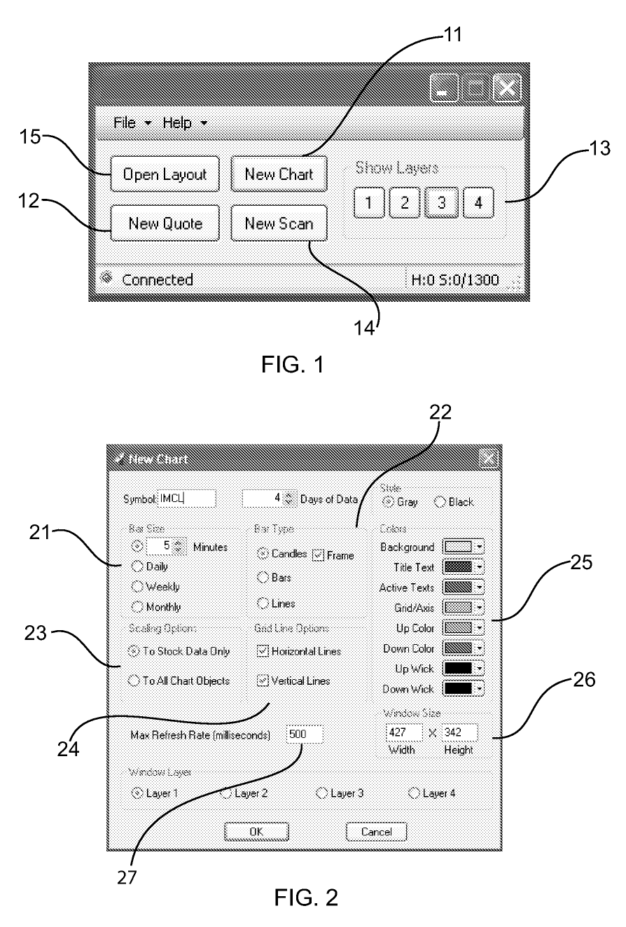

FIG. 1 depicts the main program window that allows a user to create new chart displays 11, quote sheets 12, generate new scans for trading candidates 14, and open existing layouts 15. The main program window also enables a user to select and view specific screen views or layers 13 of user grouped stocks and their corresponding charts.

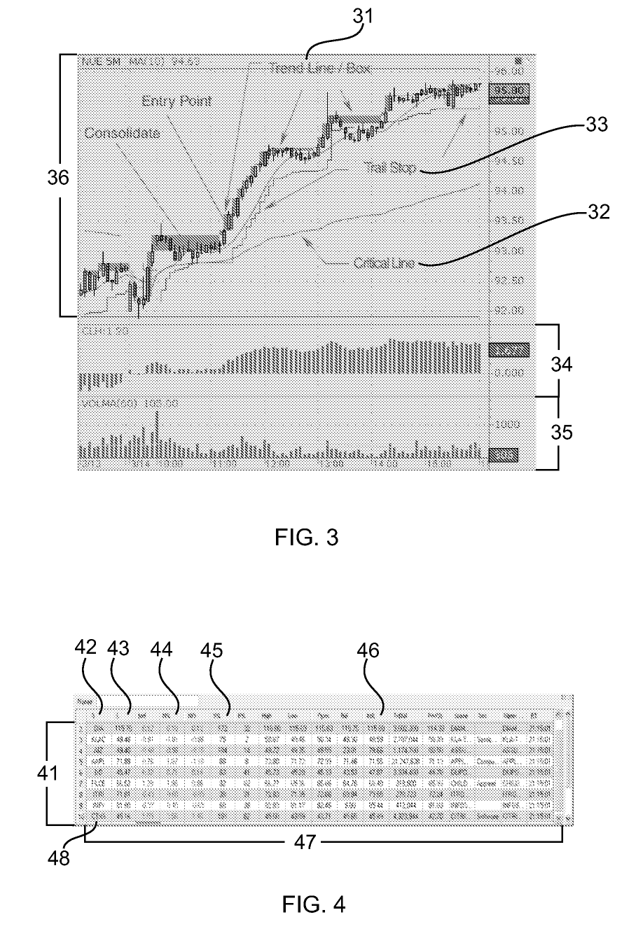

In an embodiment of the present invention, the system generates and displays stock charts in a chart display window (herein after referred to as “chart display”). A chart display can be any type of display, and not limited to a window. A chart display, as illustrated in FIG. 3, is a floating window that can be moved or positioned according to the user's preferences.

The system generates a new chart display when a user selects the “New Chart” button 11 in the main program window FIG. 1. After the “New Chart” button is selected, the system opens a user interface window FIG. 2 that allows the user to input the stock the user wishes to view. The user interface window FIG. 2 enables a user to select and modify the content and appearance of a stock chart in a chart display. The user interface window FIG. 2 allows a user to specify various characteristics of the chart. For example, selection of the chart type 21, bar type 22, scaling options 23, gridlines 24, style and color 25. The user interface window also enables a user to modify the chart display size 26 and refresh rate 27.

The content or appearance of an existing chart display can be changed or modified using a chart display menu. From the menu, the system enables a user to add and/or remove various market indicators or studies to the stock chart in the chart display FIG. 3. Studies and market indicators show information regarding a stock, such as trends. For example, FIG. 3 depicts a chart display with a number of indicators displayed contemporaneously with a stock chart. More specifically, the chart display comprises a stock chart 36, a trend line 31, critical line 32, trail stop 33, volume 35 and critical line histogram 34.

In an embodiment of the current invention, the system enables the user to modify the color, location, and properties of the market indicators as they are displayed in the chart display. The system also generates a window that displays the stock chart's statistical information.

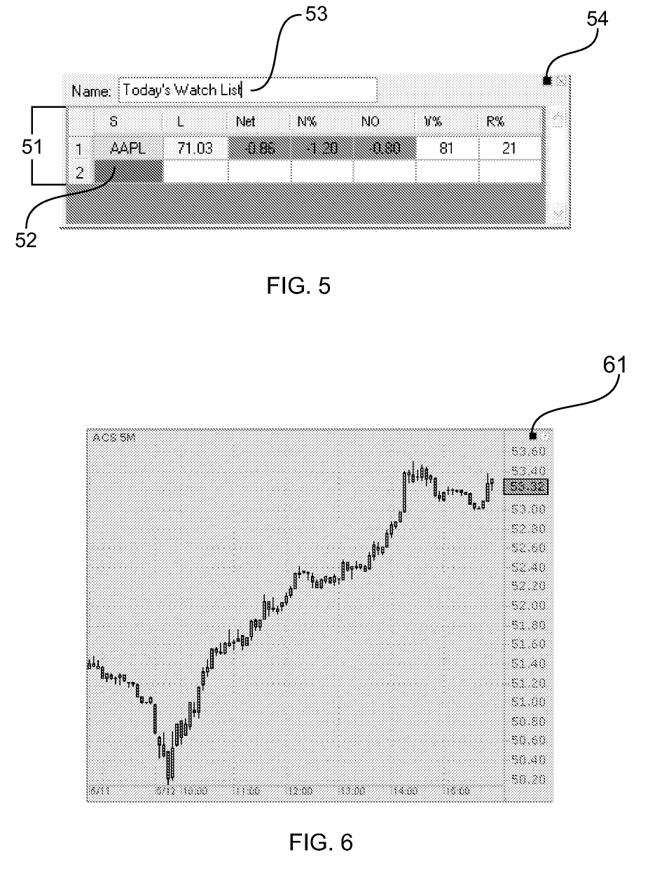

In a preferred embodiment, the system enables a user to compile, view and monitor a list of stocks in a quote sheet display FIG. 4. The system allows a user to generate a blank or new quote sheet display FIG. 4, by selecting the “New Quote” button 120 from the main program window FIG. 1. The quote sheet display allows a user to add or remove stocks from a stock list 41 by typing or deleting the ticker symbol to/from a symbol field 52. A quote sheet display FIG. 4 also enables a user to label a quote sheet 51. For example, the quote sheet 51 in FIG. 5 is label as “Today's Watch List” in the name field 53. The sequence of the stocks in the stock list 41 is either random, user defined or sorted based on a defined feature of the stocks.

The stock information maintained in a quote sheet 47 may include, for example, the last transaction price 43, the percent change from the previous day's closing price 44, percentage of the average trading volume 45, and current asking price 46.

In an embodiment of the current invention, the quote sheet display FIG. 4 enables a user to add or remove columns, change the order of column display, import ticker symbol lists, export data, and add color or highlight specified elements. Additionally, the quote sheet display enables a user to freeze the stock list 42 column to increase user efficiency of stock information viewing.

The system allows users to link a chart display FIG. 3 with a quote sheet display FIG. 4. Linking or grouping a chart display to a quote sheet display enhances a user's ability to view multiple stock charts more rapidly and efficiently.

In a preferred embodiment of the present invention, the system enables a user to link or group a chart display and a quote sheet display by color. Hereinafter, where linking occurs, grouping can also be done. For example, the system generates a new chart display FIG. 6 that is capable of linking to a quote sheet display FIG. 4. The status of whether a chart display is linked and to what quote sheet display it is linked, is indicated by the tag 61 in the upper right hand corner of the chart display FIG. 6. Other indicators are possible. A chart display is not linked to a quote sheet display when the tag 61 is black, as illustrated in FIG. 6. Like a chart display, the link status of a quote sheet display is also indicated by a tag in the upper right hand corner 54.

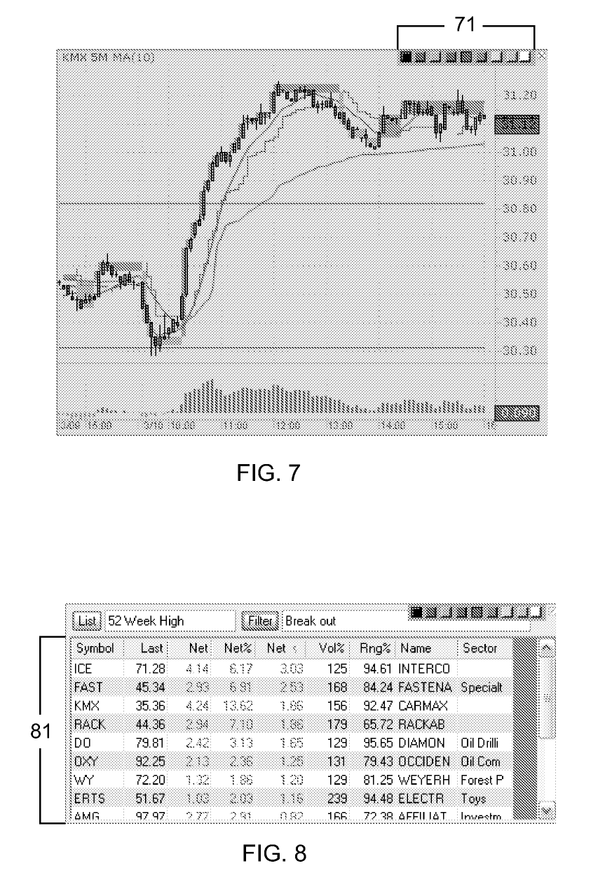

The current system allows a new chart display FIG. 6 to be linked to a quote sheet display by changing the black tag 61 to a color tag. A user selects the black tag 61 to expose nine different color tags 71, as illustrated in FIG. 7. For example, a user selects one of the nine different colors 71 to tag a chart display FIG. 7. The system links the quote sheet and chart display when the user selects the same color to tag them.

More specifically, for example, a user selects blue to tag a chart display. By selecting blue, the user links that chart display with a quote sheet display that is already tagged with blue. The blue tag now links the chart display and quote sheet display.

The system allows linking a chart display and quote sheet display with one of up to eight non-black colors. Black is a default tag for new chart and quote sheet displays, and cannot be used for linking. Other similar linking indicators are possible.

In an embodiment of the present invention, the system allows a user to view all the stock charts of a list of stocks in rapid succession. For example, a chart display and a quote sheet display are linked by a non-black color tag. The linked chart display allows a user to quickly view all the stock charts of a stock list 42 in the linked quote sheet display by selecting the stocks. The system enables a user to select a stock a number of methods.

In one method, the quote sheet display FIG. 4 enables a user to select a stock when the user positions the mouse pointer over a ticker symbol 48 in the stock list 42. For example, the user selects to view the CTXS stock chart by moving the mouse pointer over the ticker symbol 48. The chart display automatically displays the CTXS stock chart in the linked chart display when CTXS 48 is selected. Thereafter, the chart display automatically changes and shows the stock chart to the stock that is selected next. The quote sheet display allows a user to rapidly view all the stock charts of a stock list 42 by moving the mouse pointer over the ticker symbols of the stock list 42.

Alternatively, the system allows a user to select a stock by left clicking on the ticker symbol 48. For example, the linked chart display automatically displays the CTXS stock chart when the user selects the stock by left clicking on the ticker symbol 48. The system allows the next stock chart to be selected and viewed when the user left clicks on another ticker symbol from the stock list 42. The stock charts of all selected stocks are displayed and rapidly viewable in the linked chart display.

The system enables a user to link a number of chart displays to a quote sheet display at one time. For a preferred embodiment, up to twenty chart displays can be linked. The linked chart displays allow a user to rapidly view multiple stock charts instantly and simultaneously.

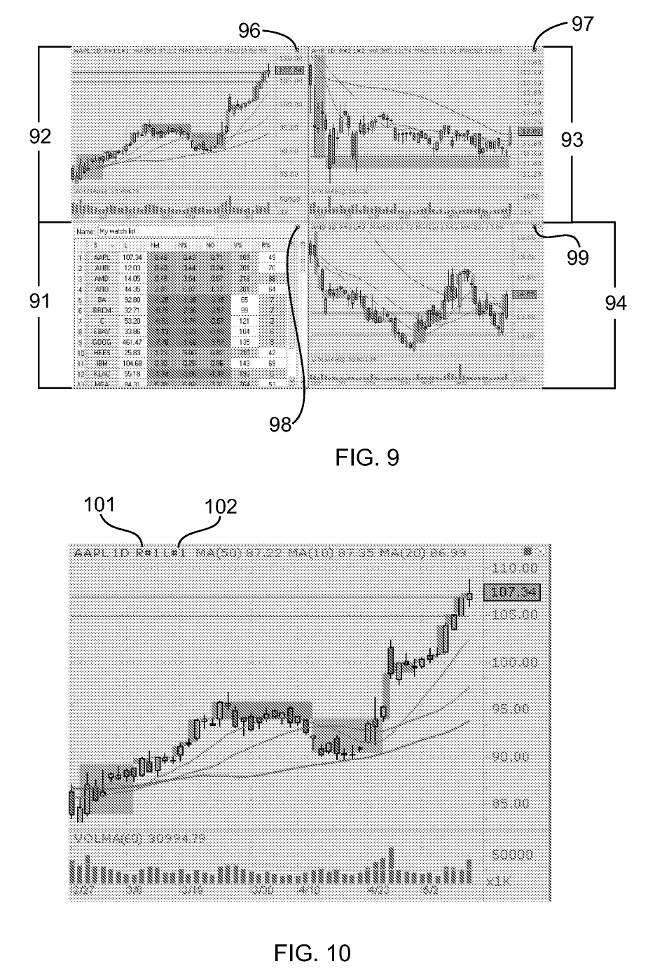

The system provides for multiple chart displays to be linked to a single quote sheet display. For example, as illustrated in FIG. 9, three chart displays 92, 93, 94 and a quote sheet display 91 are linked with blue tags located on the upper right hand corner of each display 96, 97, 99 and 98. The system allows a user to vary the number of linked chart displays. They system allows the user to generate the amount of chart displays that are simultaneously viewable in one or more computer screens.

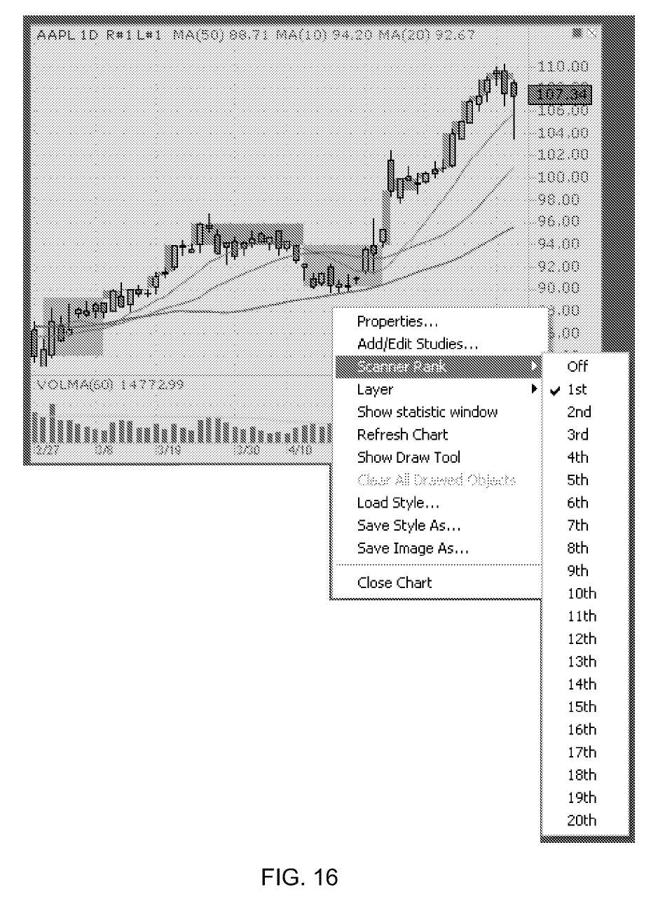

In an embodiment of the present invention, the system displays a plurality of chart displays and a quote sheet display in a patchwork quilt configuration, as illustrated in FIG. 9. The system allows a user to rank each of the linked chart displays relative to all the other linked chart displays that are viewable on the computer screen. For example, the system provides for ranking of chart displays by selecting the rank number, as illustrated in FIG. 16.

For example, as illustrated in FIG. 9, the three chart displays are ranked first display 92, second display 93 and third display 94. Ranking is shown in the upper portion 101 of each chart display, as illustrated in FIG. 10.

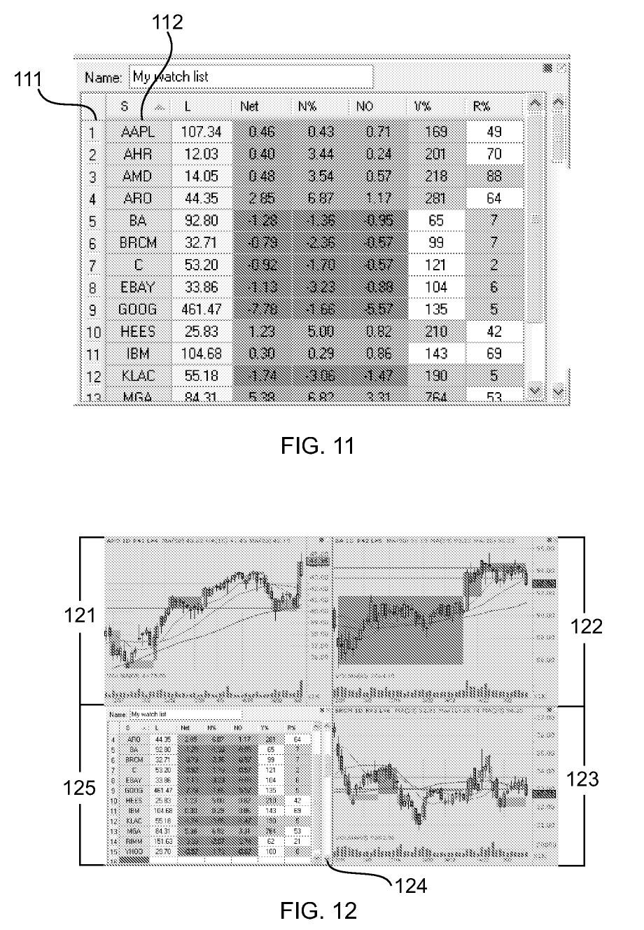

The system allows each stock in the stock list 42 to be arranged in a sequence and identified with a header 111. For example, the row header 111, as illustrated in FIG. 11, identifies and corresponds to the stock list in the quote sheet display 112. More specifically, the stocks AAPL, AHR and AMD, for example, are headed and identified by the numbers 1, 2 and 3 in the row header 111.

When the quote sheet display and ranked chart displays are linked, the system enables a user to rapidly view, in sequence, the stock charts of the stocks listed in the linked quote sheet display. For example, as illustrated in FIG. 9, the first ranked chart display 92 shows the AAPL stock chart, the second ranked chart display 93 shows the AHR stock chart, and the third ranked chart display 94 shows the AMD stock chart. Each of the stock charts is identified by the “linking number” or row header identification 102.

The system allows a user to view the previous or next group of stock charts in the sequence by scrolling up or down. In FIG. 9, for example, the user scrolls down to view the stock charts of the next three stocks (ARO, BA and BRCM) in sequence, headed and identified by 4, 5 and 6. FIG. 12 illustrates the stock charts of ARO, BA and BRCM in their corresponding ranked chart displays: ARO ranked first display 121 replacing AAPL, BA ranked second display 122 replacing AHR and BRCM ranked third display 123 replacing AMD. The linking number or header identification 102 of the stock appears in the upper portion of the corresponding chart display and can be used to reference the stock chart to the stock information in the linked quote sheet display.

In an embodiment of the present invention, the system allows a user to review stocks by scrolling through the sequence of stocks using a scroll bar 124 located on the far right side of a linked quote sheet display 125. However, a user's review of listed stocks is not limited to scrolling.

In a preferred embodiment of the present invention, the system allows a user to group chart display and quote sheet displays into designated screen views. Each chart display and quote sheet display is individually associated to a designated screen view. The designated screen view is a “layer” that can instantly be displayed in the foreground of a user's computer screen.

The system enables a user to group chart display and quote sheet displays into up to four designated screen views or layers. The designated screen views enable a user to quickly and simultaneously view stock charts while increasing user workspace. For example, a designated screen view can comprise of three chart displays and one quote sheet display in a patchwork quilt configuration, as depicted in FIG. 9. The user first associates each chart and quote sheet display the user wishes to simultaneously view to a layer, “Layer 1” for example. The system enables Layer 1 to appear in the foreground of the computer screen when the user selects the Layer 1 button in the main program window. A user can display another designated screen view on top of Layer 1 by selecting the corresponding Layer button in the main program window.

In an embodiment of the present invention, the system allows a user to group the designated screen views by category. For example, a user may use one layer for viewing call options and another for viewing short stocks.

In another embodiment of the present invention, the system allows a user to move and position the chart displays and quote sheet displays of a layer according to the user's preferences.

The system allows a user to scan the stock market for stock trading candidates. The system enables the user to initiate a scan by selecting the “New Scan” button 14 in the main program window FIG. 1. The system also allows a user to suspend or resume a scan.

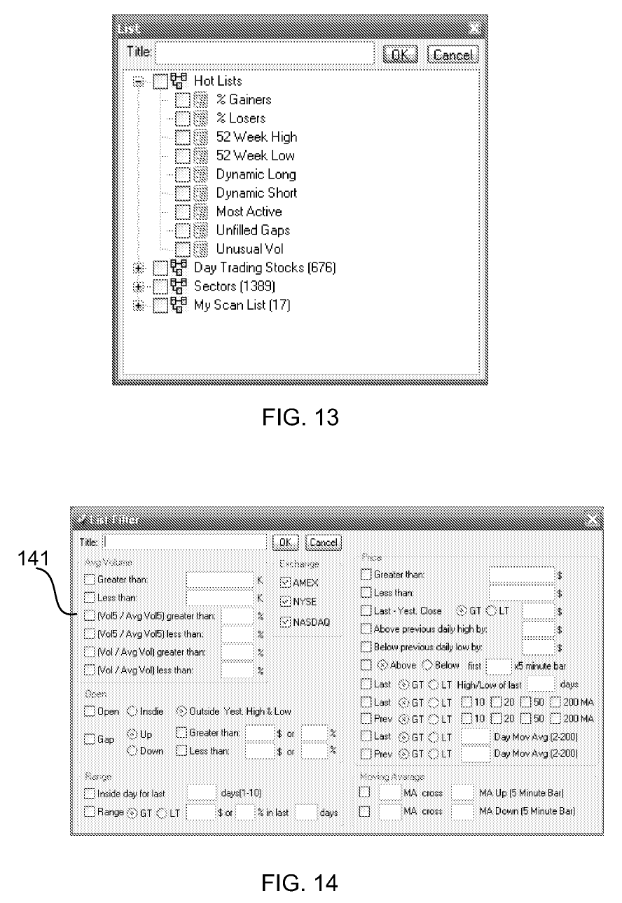

In a preferred embodiment, the system scans the stock market for stocks and selects stocks based on certain criteria. The criteria may be user specified or a pre-programmed option. Fore example, the system enables a user to scan the market using one of a number of pre-programmed options. More specifically, the pre-programmed options may comprise of broad categories such as “Hot Lists,” “Day Trading Stocks” and “Sectors,” as illustrated in FIG. 13. The system also enables a user to narrow a scan into subcategories.

The system scans the market for trading candidates by scanning the market for stocks based on specific criteria, and compiling the results into a scan list 81. The system compiles the scan list 81 into a scan sheet display FIG. 8. A scan sheet display, like the quote sheet display FIG. 4, can be linked to chart displays for viewing a scan lists' corresponding stock charts.

The following are examples of scanning options:

The system scans and identifies the most volatile stocks in the “Day Trading Stocks” category. The system first identifies the current month's most volatile stocks and sorts them by their degree of volatility. Pre-programmed subcategories in this category may include daily differences over a month averages $2 or greater, daily difference over a month averages between $1.50 to $2, daily difference over a month averages between $1 to $1.50, and daily difference over a month averages between $0.70 to $1. In an embodiment of the current invention, the system automatically sweeps the entire market every month to update this list.

The system scans stocks for upwards and downwards trends in various economic sectors when a user scans for stock candidates using the “Sectors” category. The system allows users to use the “Sectors” list to determine the best performers in upwards-trending sectors or the worst performers in the downwards-trending sectors. The system also allows users to coordinate purchases and sales with this information and overall market performance using the filters, increasing efficiency and transaction profits.

The system enables a user to scan subcategorizes of the “Sectors” list comprising areas such as, but not limited to, basic materials, consumer (cyclical), consumer (non-cyclical), energy, financial, healthcare, industrial, technology, telecommunications, and utilities. The system also enables a user to further narrow the subcategory scan to areas such as coal, communication technology, computers, advertising, medical supplies, office equipment, steel and tobacco.

In the preferred embodiment of the present invention, the system enables a user to filter a scan list 81 generated by a user defined or pre-programmed category scan. By filtering a scan list 81, the system enables a user to lower the number of results by sorting through the retrieved stocks to remove ones that do not meet more narrow criteria.

The following is an example of how the system enables a user to filter results obtained from a scan:

A user desires to search for stock trading candidates and scans for stocks satisfying the following conditions: daily trading volume larger than 800,000 shares, stock price greater than $30 (considered a high price for this market), a higher closing price than yesterday's closing price (selecting for upwards-trending stocks), trading volume 200% the average trading volume (selecting for relatively large increases), and consecutive declines for the three previous days.

If the results obtained are too few or numerous in number, the user can expand or narrow the filtering range. For example, if there are too many results after filtering, the user may change the stock price from $15 to $30 or change the daily volume from 200,000 shares to 800,000 shares.

The system allows a user to filter a scan list based on criteria such as average volume, opening price, gaps in price, price, trend and moving averages as shown in FIG. 14.

The system enables a user to filter stocks by average volume in a variety of methods 141. For example, the system calculates the average volume of a stock over the previous thirty days. The user can then focus on stocks with relatively high trading volumes, ignoring the less profitable stocks with lower volumes. The range of volumes can be set, for example, to “greater than 300,000” but “less than 5,000,000.”

The system also allows a user to filter stocks based on average volume 141 during a given period. For example, the system allows a user to filter stocks whose trading volume during the past five minutes is larger than the average trading volume of the same five-minute interval during the past three days. Alternatively, the system can filter stocks whose trading volume during the past five minutes is smaller than the average trading volume of the same five-minute interval during the past three days.

In addition, the system enables a user to filter out stocks whose daily trading volume is smaller than the average trading volume over the previous thirty-day period 141. This filtering identifies stocks that underwent large increases in trading volume.

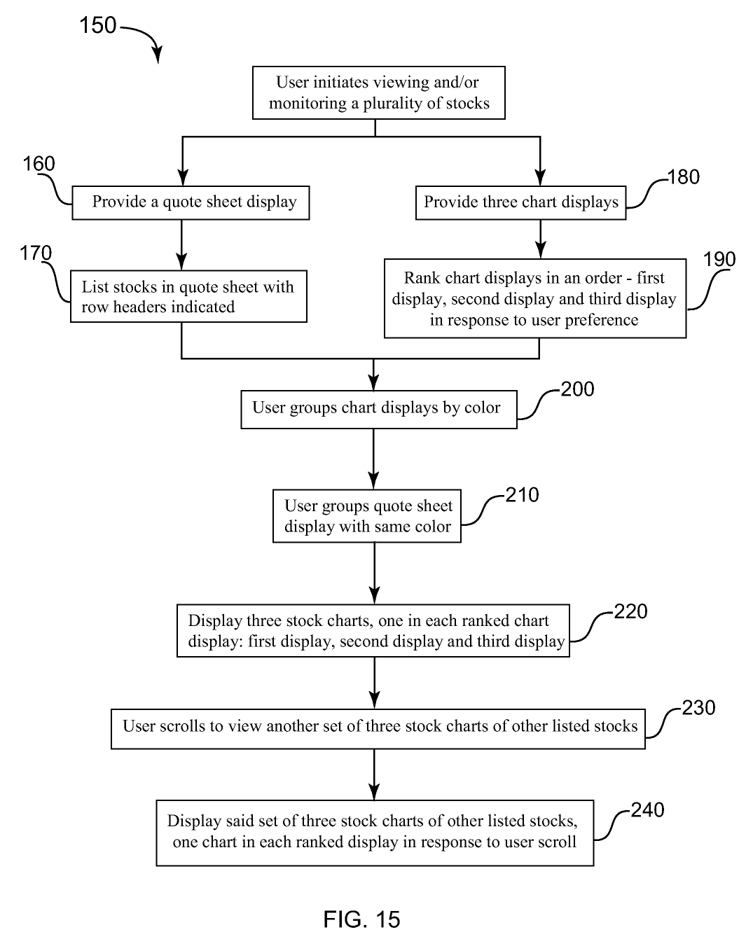

In an embodiment of the present invention, there is a method of viewing a plurality of stocks with multiple linked chart displays comprising the steps, for example, as illustrated in FIG. 15. In the embodiment, the method is implemented on the computerized system with a user. The user interacts with the system through a user interface. The following is an example an embodiment of the present invention, fewer and/or additional chart displays can be used.

In FIG. 15, the method 150 comprises the steps of providing a quote sheet display 160, listing stocks in the quote sheet with row headers 170 and providing three chart displays 180. A user ranks the chart displays 190 and groups the chart displays by color 200. A user also groups the quote sheet display with the same color 210 used to group the chart displays. Grouping the chart displays and quote sheet display are not limited solely to color.

Following the steps as described above, the method comprises the steps of displaying three stock charts, with one stock chart in each of the ranked chart displays 220. The user scrolls to view another set of three stock charts of other listed stocks in the quote sheet display 230. Other methods of reviewing stocks charts are possible and are not limited to scrolling. In response to the user scroll, three stock charts of other listed stocks are displayed, one in each of three ranked chart displays 240.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

We claim:

1. A computer implemented system connected with a communications network for displaying real-time stock market information comprising one or more processors coupled with a memory, and code stored in the memory that directs the one or more processors to:
provide a quote sheet display, listing a sequence of a plurality of stocks; and
provide a plurality of chart displays, each displaying a stock chart in real-time, wherein each of the plurality of chart displays is ranked relative to all the chart displays, hereinafter referred to as ranked chart displays, and is grouped for viewing at the same time along with the quote sheet display;
wherein the quote sheet display is linked with two or more of said ranked chart displays, such that the stock chart displayed in each of said ranked chart displays is retrieved from and corresponds to a stock in the sequence of stocks listed in the quote sheet display as selected by a user, and wherein the stock chart displayed in each of said ranked chart displays is changed to a different stock chart corresponding to a stock in the sequence of stocks as selected by the user when reviewing the sequence of stocks in said quote sheet display.

2. A computer implemented system as claimed in claim 1, wherein the quote sheet display and each chart display are grouped by color.

3. A computer implemented system as claimed in claim 1, wherein each chart display is configured to provide market indicators to be simultaneously viewed.

4. A computer implemented system as claimed in claim 1, wherein the chart displays are moveable.

5. A computer implemented system as claimed in claim 1, wherein the quote sheet display and chart displays are arranged in a patch-work quilt configuration on a display device.

6. A computer implemented system as claimed in claim 1, wherein a content of the quote sheet display is selected by a user.

7. A computer implemented system as claimed in claim 1, wherein a content of the quote sheet display is generated by a computer generated process of scanning the stock market for results that meet a criteria.

8. A computer implemented system as claimed in claim 7, wherein the computer generated process of scanning is pre-programmed.

9. A computer implemented system as claimed in claim 7, wherein the computer generated process of scanning is user-defined.

10. A computer implemented system as claimed in claim 8, wherein the results of the scanning is filtered to narrow the scope of the results.

11. A computer implemented system as claimed in claim 9, wherein the results of the scanning is filtered to narrow the scope of the results.

12. A computer implemented system as claimed in claim 1, wherein reviewing the sequence of stocks listed in said quote sheet display is performed by scrolling on said quote sheet display.

13. A computer implemented system as claimed in claim 1, wherein the chart displays are ranked in numerical order.

14. A method for displaying on a user interface a plurality of stock charts for viewing by a user comprising:
generating a quote sheet display listing a sequence of a plurality of stocks;
generating a plurality of chart displays, each displaying a stock chart in real-time;
ranking each chart display relative to all the chart displays, herein after referred to as ranked chart displays, as directed by said user;
grouping the ranked chart displays for viewing at the same time, as directed by said user;
grouping the quote sheet display in relation to the ranked chart displays, as directed by said user;
scrolling on the quote sheet display to view the stock charts of the stocks in said sequence, as directed by said user; and
displaying the stock charts of said sequence of stocks in the plurality of ranked chart displays.

15. The method of claim 14, wherein the ranking of chart displays is in numerical order.

16. The method of claim 14, wherein the grouping of said chart displays is by color.

17. The method of claim 14, wherein the grouping of said quote sheet display to said ranked chart displays is by color.

18. The method of claim 14, wherein the sequence of the plurality of stocks is computer generated.

19. The method of claim 14, wherein the sequence of the plurality of stocks is determined by said user.

20. A computer readable medium encoded with a computer program having computer executable instructions for displaying real-time stock market information, the instructions configured to:
provide a quote sheet display, listing a sequence of a plurality of stocks; and
provide a plurality of chart displays, each displaying a stock chart in real-time, wherein each of the plurality of chart displays is ranked relative to all the chart displays, hereinafter referred to as ranked chart displays, and is grouped for viewing at the same time along with the quote sheet display;
wherein the quote sheet display is linked with two or more of said ranked chart displays, such that the stock chart displayed in each of said ranked chart displays is retrieved from and corresponds to a stock in the sequence of stocks listed in the quote sheet display as selected by a user, and wherein the stock chart displayed in each of said ranked chart displays is changed to a different stock chart corresponding to a stock in the sequence of stocks as selected by the user when reviewing the sequence of stocks in said quote sheet display.
